(19) United States
(12) Patent Application Publication
(10) Pub. No.: US 2026/0080031 A1
(43) Pub. Date: Mar. 19, 2026

(54) NON-TRANSITORY COMPUTER-READABLE MEDIUM, CALCULATION METHOD, AND INFORMATION PROCESSING DEVICE

(71) Applicant: Fujitsu Limited, Kawasaki-shi (JP)

(72) Inventor: Yuma ICHIKAWA, Kawasaki (JP)

(73) Assignee: Fujitsu Limited, Kawasaki-shi (JP)

(21) Appl. No.: 19/328,652

(22) Filed: Sep. 15, 2025

(30) Foreign Application Priority Data
Sep. 18, 2024 (JP) 2024-160811

(51) Int. Cl. G06F 17/11

(52) U.S. Cl. CPC G06F 17/11

(57) ABSTRACT

There is provided a non-transitory computer-readable medium storing a calculation program for causing a computer to execute a process. The process includes, in a mixed integer programming problem including real variables and binary variables as variables to be optimized, adding a loss term according to a degree of continuity and discreteness of decision variables obtained by continuously relaxing the binary variables to a cost function obtained by continuously relaxing the binary variables without continuously relaxing the real variables, and changing the loss term according to progress of a search process for searching for a solution using the cost function.

### CROSS-REFERENCE TO RELATED APPLICATION

This application is based upon and claims the benefit of priority of Japanese Patent Application No. 2024-160811 filed on Sep. 18, 2024, the entire contents of which are incorporated herein by reference.

### FIELD

A certain aspect of the present embodiments relates to a non-transitory computer-readable medium, a calculation method, and an information processing device.

### BACKGROUND

Technologies for optimizing complex combinations have been disclosed (see, for example, Schuetz, M. J., Brubaker, J. K., and Katzgraber, H. G. (2022a). Combinatorial optimization with physics-inspired graph neural networks. Nature Machine Intelligence, 4 (4): 367-377, and Schuetz, M. J., Brubaker, J. K., Zhu, Z., and Katzgraber, H. G. (2022b). Graph coloring with physics-inspired graph neural networks. Physical Review Research, 4(4):043131.)

### SUMMARY

According to an aspect of the present disclosure, there is provided a non-transitory computer-readable medium storing a calculation program for causing a computer to execute a process, the process including: in a mixed integer programming problem including real variables and binary variables as variables to be optimized, adding a loss term according to a degree of continuity and discreteness of decision variables obtained by continuously relaxing the binary variables to a cost function obtained by continuously relaxing the binary variables without continuously relaxing the real variables, and changing the loss term according to progress of a search process for searching for a solution using the cost function.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates GNN;

FIG. 2 illustrates GNN;

FIG. 3A is a functional block diagram of an overall configuration of an information processing device according to an embodiment;

FIG. 3B is a hardware configuration diagram of an information processing device;

FIG. 4 is a flowchart of an example of an operation of an information processing device during machine learning; and

FIG. 5 is a flowchart of an example of an operation of an information processing device when outputting an approximate solution to an optimization problem using results of machine learning model.

### DESCRIPTION OF EMBODIMENTS

In combinatorial optimization, it is considered to search for an optimal solution by a continuous relaxation method using a machine learning model. However, in the continuous relaxation method, the solution found may differ from the original solution. This may result in a decrease in the accuracy of solving the combinatorial optimization problem.

Optimization problems exist in various industries, including the manufacturing and distribution industries. In particular, combinatorial optimization problems, which optimize combinations, are one of the most important fields in the field of optimization. Combinatorial optimization problems are applied in various fields, such as transportation, logistics, communication, and finance.

Constrained combinatorial optimization problems are the most important problem in combinatorial optimization problems, and have many practical applications. For example, general-purpose solvers such as Ising machines use the penalty method to search for constraint-satisfying solutions. However, general-purpose solvers have difficulty finding a solution depending on the penalty coefficient. In addition, with local transition algorithms such as Ising machines, it is difficult to search for only local solutions, so it is difficult to obtain multiple solutions at once.

Here, an overview of constrained combinatorial optimization problems will be described. First, the penalty method will be given. Constrained optimization problems are expressed by the following formula (1). In general, in f(x;A), “x” represents the variable to be optimized, and “A” represents a constant that is not the object of optimization. Therefore, in the following formula (1), “C” represents a constant and is a parameter that characterizes the problem example. C is, for example, a graph G(V,E). x represents a variable, which is a vector represented by 0 and 1 and has N elements. Also, “s.t.” stands for “subject to”. “f” is represented by the following formula (2) and represents a cost function. The feasible region is represented by the following formula (3). The following formula (4) represents an equality constraint in the feasible region. The following formula (5) represents an inequality constraint in the feasible region.

$$\begin{matrix}[ Formula 1 ] & \\ {min}_{x ∈ {\{ 0 , 1 \}}^{N}} f ( x ; C ) s . t . x ∈ 𝒳 ( C ) & ( 1 )\end{matrix}$$

$$\begin{matrix}[ Formula 2 ] & \\ 𝒳 \times C \to ℝ & ( 2 )\end{matrix}$$

$$\begin{matrix}[ Formula 3 ] & \\ 𝒳 ( C ) = \{ x ∈ {\{ 0 , 1 \}}^{N} \vert ∀ i ∈ [ I ] , {g}_{i} ( x ; C ) \leq 0 , ∀ j ∈ [ J ] , {h}_{j} ( x ; C ) = 0 \} & ( 3 )\end{matrix}$$

$$\begin{matrix}[ Formula 4 ] & \\ i ∈ [ I ] , {g}_{i} : {\{ 0 , 1 \}}^{N} \times C \to ℝ & ( 4 )\end{matrix}$$

$$\begin{matrix}[ Formula 5 ] & \\ j ∈ [ J ] , {h}_{j} : {\{ 0 , 1 \}}^{N} \times C \to ℝ & ( 5 )\end{matrix}$$

In the penalty method, constrained combinatorial optimization is considered as an optimization problem of the following formula (6). That is, in the penalty method, the penalty term of the second term on the right side is introduced.

$$\begin{matrix}[ Formula 6 ] & \\ {min}_{x} l ( x ; C , λ ) , l ( x ; C , λ ) = f ( x ; C ) + {\sum }_{i = 1}^{I + J} {λ}_{i} {v}_{i} ( x ; C ) & ( 6 )\end{matrix}$$

The following equation (7) represents the penalty term, and is typically defined as the following equations (8) and (9).

$$\begin{matrix}[ Formula 7 ] & \\ i ∈ [ I + J ] , v : {\{ 0 , 1 \}}^{N} \times C \to ℝ & ( 7 )\end{matrix}$$

$$\begin{matrix}[ Formula 8 ] & \\ ∀ i ∈ [ I ] , {v}_{i} ( x ; C ) = max ( 0 , {g}_{i} ( x ; C ) ) [ Inequality ] & ( 8 )\end{matrix}$$

$$\begin{matrix}[ Formula 9 ] & \\ ∀ j ∈ [ J ] , {v}_{j} ( x ; C ) = {( {h}_{j} ( x ; C ) )}^{2} [ Equality ] & ( 9 )\end{matrix}$$

“λ” in the following formula (10) is a penalty coefficient, a parameter for controlling the balance between the cost function and the penalty term. In the penalty method, it is necessary to appropriately adjust the penalty coefficient.

$$\begin{matrix}[ Formula 10 ] & \\ λ = {( {λ}_{i} )}_{l \leq i \leq I + J} ∈ {ℝ}^{I + J} & ( 10 )\end{matrix}$$

In the above penalty method, it is difficult to adjust the parameter λ. For example, if λ is too large, the solution being searched for is likely to be a local solution, and if λ is too small, the solution being searched for is likely to violate constraints.

Next, we will explain combinatorial optimization using machine learning. Along with the development of information science, technology that aims to solve combinatorial optimization problems quickly using machine learning has been developed. One of these technologies is an optimization solution method using the continuous relaxation solution method.

The continuous relaxation solution method is a method for approximately solving a combinatorial optimization problem as a continuous optimization problem. Instead of solving a discrete optimization problem, it is a method of relaxing discrete variables to continuous variables and solving a continuous optimization problem corresponding to the discrete optimization problem. A continuous optimization problem can be expressed as in the following formula (11). In the following formula (11), [0,1]^{N} represents an N-dimensional hypercube lattice that takes the value 0 or 1. In the following formula (11), the variable vector “p” is the variable to be optimized.

$$\begin{matrix}[ Formula 11 ] & \\ {min}_{p ∈ {[ 0 , 1 ]}^{N}} \hat{l} ( p ; C , λ ) , \hat{l} ( p ; C , λ ) = \hat{f} ( p ; C ) + {\sum }_{i = 1}^{m + p} {λ}_{i} {\hat{v}}_{i} ( p ; C ) & ( 11 )\end{matrix}$$

In the above formula (11), the following formula (12) is generally converted to the following formula (13) for any x∈{0,1}^{N}.

$$\begin{matrix}[ Formula 12 ] & \\ \hat{f} {: [ 0 , 1 ]}^{N} \times C \to ℝ & ( 12 )\end{matrix}$$

$$\begin{matrix}[ Formula 13 ] & \\ \hat{f} ( x ; C ) = f ( x ; C ) & ( 13 )\end{matrix}$$

However, even when the continuous relaxation solution method is used, it is still difficult to adjust the penalty coefficient λ.

Therefore, it has been considered to apply the continuous relaxation annealing method to the continuous relaxation solution method. In the continuous relaxation annealing method, the variable p is parameterized using a statistical model, and the loss function of the following formula (14) is optimized.

$$\begin{matrix}[ Formula 14 ] & \\ \hat{r} ( {p}_{θ} ; C , λ , γ ) = \hat{l} ( {p}_{θ} ; C , γ , α ) + Φ ( {p}_{θ} ; C , γ , α ) , Φ ( {p}_{θ} ; C , γ , α ) = γ {\sum }_{i = 1}^{N} ( 1 - {( 2 {p}_{θ , i} - 1 )}^{α} ) & ( 14 )\end{matrix}$$

“λ” is a parameter for controlling the loss term in the above formula (14), and is a hyper parameter for controlling the degree of continuity and discreteness. For example, in the following formula (15), when γ is negative, the relaxation variable p_{θ} prefers the half-integral value ½, and when γ is positive, the relaxation variable p_{θ} prefers the binary value {0, 1}.

$$\begin{matrix}[ Formula 15 ] & \\ α ∈ \{ 2 n + 1 \vert n ∈ ℕ ) , γ & ( 15 )\end{matrix}$$

As machine learning progresses, the hyper parameter λ is gradually changed from a negative value λ⁽⁰⁾<0 to a positive value λ^{(T)}>0. As a result, the loss term changes from one in which the loss is smaller the more continuous the discrete vector p is to one in which the loss is larger the more continuous the discrete vector p is. For example, if λ is −∞, the output solution is ½. If A is too, the output solution is a discrete variable of 0 or 1. This method is sometimes called the continuous relaxation annealing method. By controlling in this way, machine learning ends when the discrete vector becomes almost a discrete value.

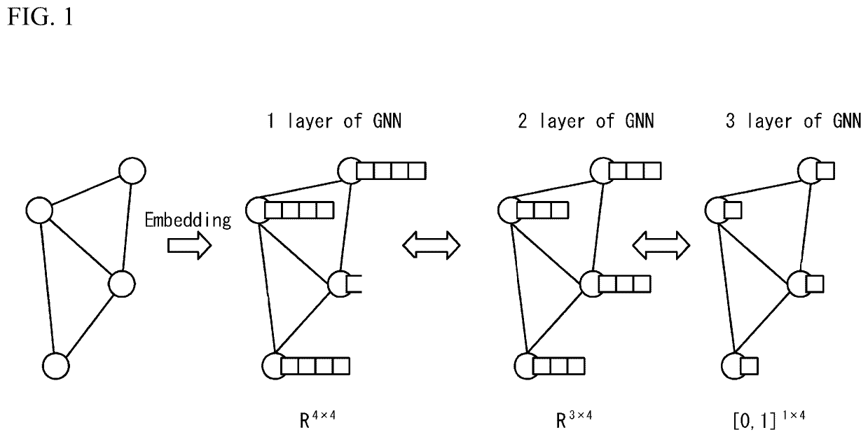

As an example, an example in which the variable vector p is parameterized in a GNN (Graph Neural Network) and optimized will be described. “G” is the feature vector of the graph in the GNN. For example, in FIG. 1, the feature vector G of the graph is converted into a graph embedding vector with the number of nodes N=4 and the number of edges E=4. Note that R^{E×N} is an E×N-dimensional Euclidean space. In this optimization, the graph G of the optimization problem is embedded in R^{H×N} as an embedding vector, and [0, 1]^{1×4} is output.

However, the continuous relaxation annealing method is not directly applied to mixed integer programming problems that include real decision variables.

Then, in the following embodiment, an example in which continuous relaxation annealing can be applied to a mixed integer programming problem that includes real decision variables is described.

### EMBODIMENT

First, the principle of this embodiment will be described. In this embodiment, a mixed integer programming problem including real variables (continuous variables) and discrete variables (binary variables) is handled. As an example, when searching for an optimal solution for the price of a product, the purchase price of the product is treated as a discrete variable, and the actual selling price is treated as a real variable.

Among the variables in the mixed integer programming problem, the real variables are expressed by the following formula (16). “R” represents a real number. Next, the binary variables are expressed by the following formula (17). The real variables are not relaxed, and only the binary variables are continuously relaxed as expressed in the following formula (18) to obtain decision variables. Using these decision variables, for example, the optimization problem of the following formula (19) is solved.

$$\begin{matrix}[ Formula 16 ] & \\ α ∈ {ℝ}^{{N}_{α}} & ( 16 )\end{matrix}$$

$$\begin{matrix}[ Formula 17 ] & \\ β ∈ {\{ 0 , 1 \}}^{{N}_{β}} & ( 17 )\end{matrix}$$

$$\begin{matrix}[ Formula 18 ] & \\ β \to p ∈ {[ 0 , 1 ]}^{{N}_{β}} & ( 18 )\end{matrix}$$

$$\begin{matrix}[ Formula 19 ] & \\ \hat{r} = \hat{l} ( α , p ; C , λ ) + Φ ( p ; C , γ , α ) , Φ ( p ; C , γ , s ) = γ {\sum }_{i = 1}^{N} ( 1 - {( 2 {p}_{i} - 1 )}^{s} ) & ( 19 )\end{matrix}$$

In the above formula (19), “Φ” acts only on the decision variables that were binary variables. Therefore, by increasing γ, the continuous relaxed variables also asymptotically approach the binary values {0, 1}. Note that since the second term acts only on the decision variables that are originally binary variables, the range of the real variables in the above formula (16) is not affected, and the range of only the relaxed binary variables is limited to {0, 1}. From the above, it is possible to improve the accuracy of solving combinatorial optimization problems.

An example of applying this solving principle to an unsupervised learning solver will be described. As an example, “α” and “p” are characterized by a statistical model as expressed in the following formula (20). Here, if the space that θ can take is H, the statistical model is defined to satisfy the following formula (21).

$$\begin{matrix}[ Formula 20 ] & \\ \hat{r} ( {α}_{θ} , {p}_{θ} ; C , λ , γ ) = \hat{l} ( {α}_{θ} , {p}_{θ} ; C , λ ) + Φ ( {p}_{θ} ; C , γ , α ) , Φ ( {p}_{θ} ; C , γ , α ) = γ {\sum }_{i = 1}^{N} ( 1 - {( 2 {p}_{θ , i} - 1 )}^{α} ) & ( 20 )\end{matrix}$$

$$\begin{matrix}[ Formula 21 ] & \\ α : ℋ \times C \to {ℝ}^{{N}_{α}} , p : ℋ \times C \to {[ 0 , 1 ]}^{{N}_{β}} & ( 21 )\end{matrix}$$

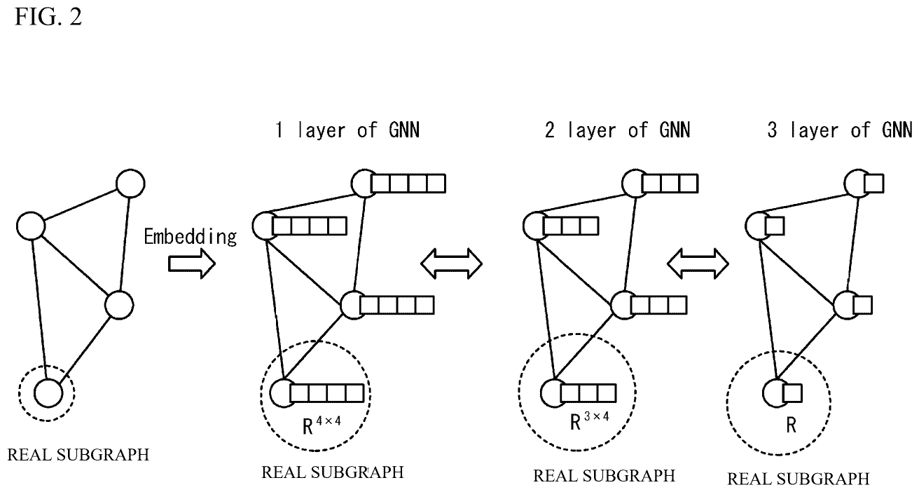

Next, a case where a GNN is used as a statistical model will be described. In this case, as illustrated in FIG. 2, the graph is divided into a subgraph for binary variables and a subgraph for real numbers, and the output of the final layer is defined to be the following formula (22). In FIG. 2, the area enclosed by the dotted line is the subgraph for real numbers.

$$\begin{matrix}[ Formula 22 ] & \\ {[ 0 , 1 ]}^{{N}_{β}} \times {ℝ}^{{N}_{α}} & ( 22 )\end{matrix}$$

Next, the above solution principle will be verified. As an example, the real variable α1 and the binary variables β1 to β3 are expressed by the following formula (23). Using these variables, a simple mixed integer programming problem of the following formula (24) is considered.

$$\begin{matrix}[ Formula 23 ] & \\ ( {α}_{1} ∈ ℝ , {β}_{1} , {β}_{2} , {β}_{3} ∈ \{ 0 , 1 \} ) & ( 23 )\end{matrix}$$

$$\begin{matrix}[ Formula 24 ] & \\ f ( {α}_{1} , {β}_{1} , {β}_{2} , {β}_{3} ; λ ) = - {\sum }_{i = 1}^{3} {β}_{i} + {{β}_{1} ( α - 0.3 )}^{2} + λ \vert {β}_{3} \vert + Φ ( p ; γ , α ) & ( 24 )\end{matrix}$$

The global optimal solution of the above formula (23) is the following formula (25).

$$\begin{matrix}[ Formula 25 ] & \\ ( {α}_{1} ∈ ℝ , {β}_{1} , {β}_{2} , {β}_{3} ) = ( 0.3 , 1 , 1 , 0 ) & ( 25 )\end{matrix}$$

For this problem, as expressed in the following formula (26), Φ is added by continuous relaxation. Then, the relaxed variable pe is characterized by the GNN and solved, and the global optimal solution of the above formula (25) has been successfully obtained.

$$\begin{matrix}[ Formula 26 ] & \\ f ( {α}_{1} , {p}_{1} , {p}_{2} , {p}_{3} ; λ ) = - {\sum }_{i = 1}^{3} {p}_{i} + {{p}_{1} ( α - 0.3 )}^{2} + λ \vert {p}_{3} \vert + Φ ( p ; γ , α ) & ( 26 )\end{matrix}$$

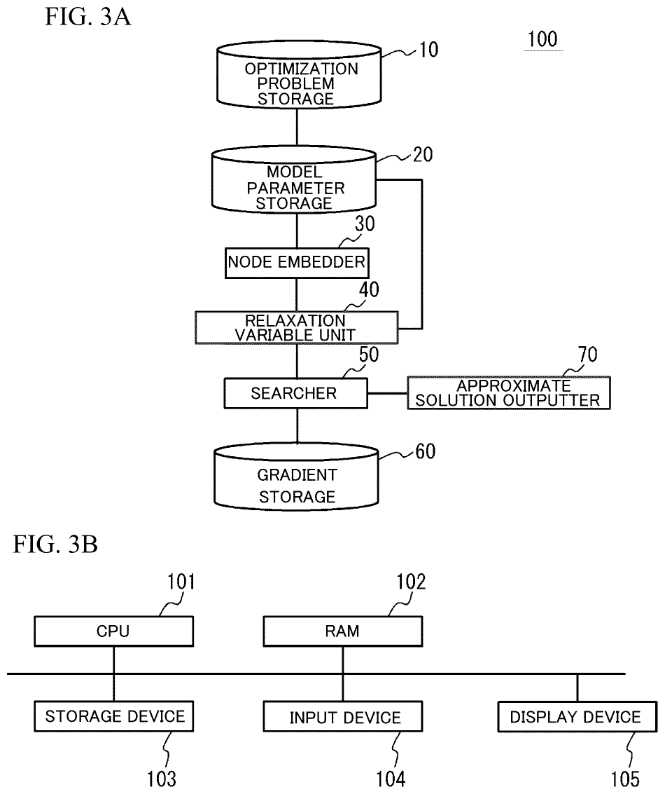

Next, the device configuration for realizing the above solution principle will be described. FIG. 3A is a functional block diagram of the overall configuration of an information processing device 100 according to the embodiment. The information processing device 100 is a server for optimization processing, or the like. As illustrated in FIG. 3A, the information processing device 100 functions as an optimization problem storage 10, a model parameter storage 20, a node embedder 30, a relaxation variable unit 40, a searcher 50, a gradient storage 60, an approximate solution outputter 70 and so on.

For example, in a mixed integer programming problem including real variables and binary variables as variables to be optimized, the searcher 50 adds a loss term according to the degree of continuity and discreteness of the decision variable obtained by continuously relaxing the binary variables to a cost function obtained by continuously relaxing the binary variables without continuously relaxing the real variables, and changes the loss term according to the progress of the searching in which a solution is searched for using the cost function.

In addition, as the searching progresses, the searcher 50 changes the loss term from one in which the loss is smaller the more continuous the decision variable is, to one in which the loss is larger the more continuous the decision variable is.

In addition, the searcher 50 machine-learns the model by repeatedly changing the loss term, changing the model parameters of the model in which the mixed integer programming problem is embedded, and calculating the cost function and the loss term.

FIG. 3B is a hardware configuration diagram of the information processing device 100. As illustrated in FIG. 3B, the information processing device 100 includes a CPU 101, a RAM 102, a storage device 103, an input device 104, a display device 105, and the like.

The CPU 101 is a central processing unit. The CPU 101 includes one or more cores. The RAM (Random Access Memory) 102 is a volatile memory that temporarily stores the program executed by the CPU 101 and the data processed by the CPU 101. The storage device 103 is a non-volatile storage device. For example, a ROM (Read Only Memory), a solid state drive (SSD) such as a flash memory, or a hard disk driven by a hard disk drive can be used as the storage device 103. The storage device 103 stores a calculation program. The input device 104 is a device for a user to input necessary information, such as a keyboard or a mouse. The display device 105 is a display device that displays the sampling results output by the approximate solution outputter 70 on a screen. Each part of the information processing device 100 is realized by the CPU 101 executing the calculation program. Note that each part of the information processing device 100 may be hardware such as a dedicated circuit.

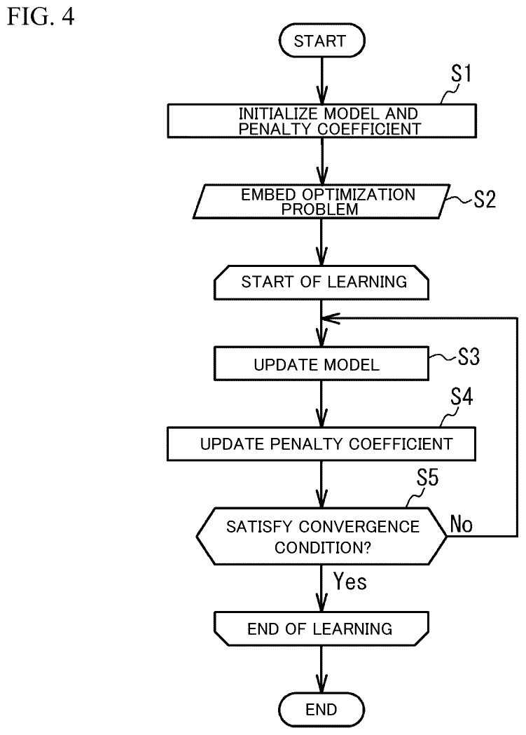

FIG. 4 is a flowchart of an example of the operation of the information processing device 100 during machine learning. As illustrated in FIG. 4, the searcher 50 initializes the model (step S1). Specifically, the searcher 50 sets the model parameters stored in the model parameter storage 20 to predetermined initial values.

Next, the node embedder 30 embeds the optimization problem (step S2). For example, in a problem using a graph, the node embedder 30 converts the graph feature vector of the given optimization problem into an embedding vector. The relaxation variable unit 40 sets the dynamic variables to be relaxed, which are parameterized by the neural network. At that time, the real variables are not continuously relaxed, and only the binary variables are continuously relaxed. As a result, the loss function expressed by the above formula (19) is obtained.

Next, the searcher 50 updates the model parameters by gradient descent (step S3). The model parameters are updated using the gradient stored in the gradient storage 60. When step S3 is executed for the first time, the model parameters are not updated.

Next, the searcher 50 adjusts the degree of discrete-continuous (step S4). Specifically, the searcher 50 calculates the loss function while gradually changing the hyper parameter λ in the above formula (19) from a negative value λ⁽⁰⁾<0 to a positive value λ^{(T)}>0.

Next, the searcher 50 determines whether or not the convergence condition is satisfied (step S5). For example, it is determined whether or not the loss function of the above formula (19) is no longer smaller than a specified value even when step S4 is executed repeatedly. If the determination in step S5 is “No”, the process is executed again from step S3.

If the determination in step S5 is “Yes”, the execution of the flowchart ends. In this case, the model parameter storage 20 stores the model parameters when the loss function is smallest.

The machine learning in FIG. 4 makes it possible to obtain a machine learning model that minimizes the loss function of the above formula (19). The machine learning model (model parameters) are stored in the model parameter storage 20.

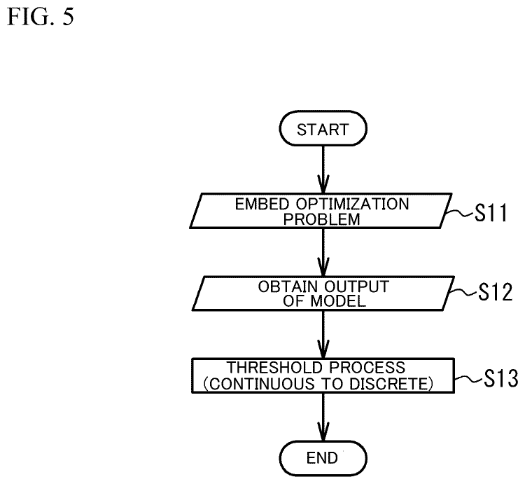

FIG. 5 is a flowchart of an example of the operation of the information processing device 100 when outputting an approximate solution to an optimization problem using the results of the machine learning model obtained by the machine learning in FIG. 4. As illustrated in FIG. 5, the node embedder 30 embeds the optimization problem (step S11).

Next, the approximate solution outputter 70 acquires the output of the machine learning model (step S12).

Next, the approximate solution outputter 70 performs threshold processing on the optimal solution output by the machine learning model (step S13). For example, a threshold is set for each value output by the machine learning model to binarize the value. For example, when converting each value into a binary value of 0 or 1, the threshold value is set to 0.5, and values greater than 0.5 are set to 1, and values less than 0.5 are set to 0.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A non-transitory computer-readable medium storing a calculation program for causing a computer to execute a process, the process comprising:
in a mixed integer programming problem including real variables and binary variables as variables to be optimized, adding a loss term according to a degree of continuity and discreteness of decision variables obtained by continuously relaxing the binary variables to a cost function obtained by continuously relaxing the binary variables without continuously relaxing the real variables, and changing the loss term according to progress of a search process for searching for a solution using the cost function.

2. The non-transitory computer-readable medium according to claim 1,
wherein as the search process progresses, the loss term is changed from one that causes less loss the more continuous the decision variables are to one that causes more loss the more continuous the decision variables are.

3. The non-transitory computer-readable medium according to claim 1,
wherein the process comprises machine-learning a model in which the mixed integer programming problem is embedded by repeating steps of: changing a model parameter of the model; and calculating the cost function and the loss term.

4. A calculation method implemented by a computer, the method comprising:
in a mixed integer programming problem including real variables and binary variables as variables to be optimized, adding a loss term according to a degree of continuity and discreteness of decision variables obtained by continuously relaxing the binary variables to a cost function obtained by continuously relaxing the binary variables without continuously relaxing the real variables, and changing the loss term according to progress of a search process for searching for a solution using the cost function.

5. The method according to claim 4,
wherein as the search process progresses, the loss term is changed from one that causes less loss the more continuous the decision variables are to one that causes more loss the more continuous the decision variables are.

6. The method according to claim 4, further comprising:
machine-learning a model in which the mixed integer programming problem is embedded by repeating steps of: changing a model parameter of the model; and calculating the cost function and the loss term.

7. An information processing device comprising:
a memory; and
a processor coupled to the memory and the processor configured to execute a process, the process comprising:
in a mixed integer programming problem including real variables and binary variables as variables to be optimized, adding a loss term according to a degree of continuity and discreteness of decision variables obtained by continuously relaxing the binary variables to a cost function obtained by continuously relaxing the binary variables without continuously relaxing the real variables, and changing the loss term according to progress of a search process for searching for a solution using the cost function.

8. The information processing device according to claim 7,
wherein as the search process progresses, the loss term is changed from one that causes less loss the more continuous the decision variables are to one that causes more loss the more continuous the decision variables are.

9. The information processing device according to claim 7,
wherein the process comprises machine-learning a model in which the mixed integer programming problem is embedded by repeating steps of: changing a model parameter of the model; and calculating the cost function and the loss term.
